(19) United States
(12) Patent Application Publication
(10) Pub. No.: US 2017/0262141 A1
(43) Pub. Date: Sep. 14, 2017

(54) INFORMATION PROCESSING APPARATUS, INFORMATION PROCESSING METHOD AND NON-TRANSITORY COMPUTER READABLE MEDIUM

(71) Applicant: FUJI XEROX CO., LTD., Tokyo (JP)

(72) Inventor: Kazuhiro SOGA, Yokohama-shi (JP)

(73) Assignee: FUJI XEROX CO., LTD., Tokyo (JP)

(21) Appl. No.: 15/216,135

(22) Filed: Jul. 21, 2016

(30) Foreign Application Priority Data
Mar. 10, 2016 (JP) 2016-046521

(51) Int. Cl. G06F 3/0482; G06F 17/22; G06F 17/24

(52) U.S. Cl. CPC G06F 3/0482; G06F 17/248; G06F 17/2205

(57) ABSTRACT

An information processing apparatus is provided with a display control unit and an output creating unit. The display control unit displays a region to be displayed, which is disposed on a multi-dimensional template impression map, on a display unit. The multi-dimensional template impression map is configured such that a plurality of templates related to creation of designs and evoking different impressions are mapped in accordance with impressions of the templates. The output creating unit creates an output using a template selected among the plurality of templates mapped on the template impression map.

This application is based on and claims priority under 35 USC 119 from Japanese Patent Application No. 2016-046521 filed on Mar. 10, 2016.

### BACKGROUND

The present invention relates to an information processing apparatus, an information processing method and a non-transitory computer readable medium.

### SUMMARY

In accordance with an aspect of the invention, an information processing apparatus is provided with a display control unit and an output creating unit. The display control unit displays a region to be displayed, which is disposed on a multi-dimensional template impression map, on a display unit. The multi-dimensional template impression map is configured such that a plurality of templates related to creation of designs and evoking different impressions are mapped in accordance with impressions of the templates. The output creating unit creates an output using a template selected among the plurality of templates mapped on the template impression map.

### BRIEF DESCRIPTION OF THE DRAWINGS

Exemplary embodiments of the present invention will be described in detail based on the following figures, wherein:

FIG. 1 is a block diagram showing a design creating system according to an exemplary embodiment of the invention;

FIG. 2 is a block diagram showing the design creating apparatus according to this exemplary embodiment;

FIG. 3 is a block diagram showing a terminal apparatus;

FIG. 4 is a schematic diagram showing a configuration of a template;

FIG. 5 is a diagram showing an example of a template impression map;

FIG. 6 is a diagram showing an example of a title character impression map;

FIG. 7 is a diagram showing an example of a body character impression map;

FIG. 8 is a diagram showing an example of an image impression map;

FIG. 9 is a diagram showing an example of a figure color impression map;

FIG. 10 is a diagram showing an example of a figure shadow impression map;

FIG. 11 is a flow chart showing a process of creating a template impression map;

FIG. 12 is a diagram showing an example of a template impression map;

FIG. 13 is a diagram showing an example of a template impression map having a normal size;

FIG. 14 is a diagram showing an example of a reduced template impression map;

FIG. 15 is a diagram showing an example of a template impression map;

FIG. 16 is a diagram showing an example of a display window;

FIG. 17 is a diagram showing an example of a display window;

FIG. 18 is a diagram showing an example of a template impression map having a normal size; and

FIG. 19 is a diagram showing an example of a reduced template impression map.

### DETAILED DESCRIPTION

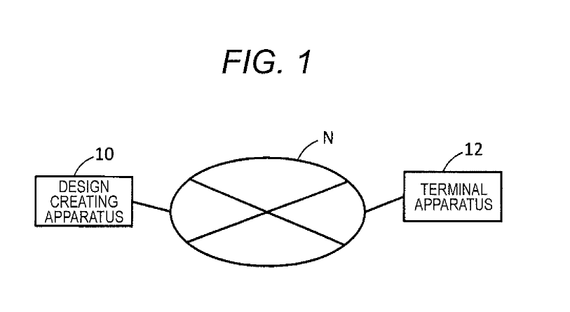

Now, a design creating system as an information processing system according to an exemplary embodiment of the invention will be described. FIG. 1 shows an example of a design creating system according to this exemplary embodiment. The design creating system includes a design creating apparatus 10 as an information processing apparatus and a terminal apparatus 12. The design creating apparatus 10 and the terminal apparatus 12 are connected to a communication channel N such as a network. In the example shown in FIG. 1, one terminal apparatus 12 is connected to the communication channel N, but plural terminal apparatuses 12 may be connected to the communication channel N.

The design creating apparatus 10 is an apparatus that stores data of a template regarding the design creation of an object, provides the data of the template, edits the template in accordance with a user's instruction, and provides an output (for example, image data or the like) as the compilation thereof. The object is, for example, a business card, a flyer, an advertisement, a direct mail (DM), a poster, a postcard, a catalog, other documents, clothes, a car, a building, a bridge, or the like. In addition, the design creating apparatus 10 has a function of transmitting and receiving data to and from another apparatus.

The terminal apparatus 12, which is an apparatus such as a personal computer (PC), a tablet PC, a smartphone, or a mobile phone, has a function of transmitting and receiving data to and from another apparatus. The terminal apparatus 12 is used, for example, at the time of creating a design of an object.

In this exemplary embodiment, a template impression map having plural templates of different designs mapped thereto is provided from the design creating apparatus 10 to the terminal apparatus 12. A specific template is designated in the terminal apparatus 12, and an output is created using the template.

Meanwhile, the terminal apparatus 12 may be embedded in the design creating apparatus 10 so that the design creating apparatus 10 and the terminal apparatus 12 are physically integrated with each other.

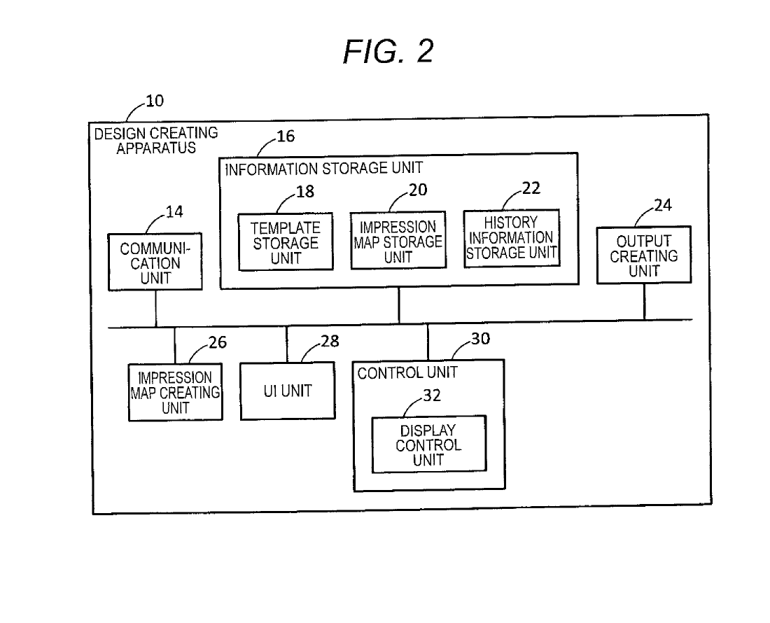

Hereinafter, a configuration of the design creating apparatus 10 will be described in detail with reference to FIG. 2. FIG. 2 shows a configuration of the design creating apparatus 10.

A communication unit 14, which is a communication interface, has a function of transmitting data to another apparatus and a function of receiving data from another apparatus through a communication channel N. For example, data of a template impression map is transmitted to the terminal apparatus 12 by the communication unit 14, and information transmitted from the terminal apparatus 12 is received.

The information storage unit 16, which is a storage device such as a hard disk, includes a template storage unit 18, an impression map storage unit 20, and a history information storage unit 22.

Pieces of data of plural templates having different designs are stored in the template storage unit 18 in advance. The template is a form of a design for an object. Plural templates having different designs are created in advance for each object and are stored in the template storage unit 18. For example, plural templates having different designs are created in advance for a business card. The same is true of other objects. Each template is associated with identification information (for example, the name of a template, a template ID, and the like) for identifying the template, information indicating the use of a template (object suitable for a template), information indicating a taste evoked by a template, and the like. The template is retrieved using these pieces of information. The taste is determined in advance in accordance with, for example, a taste model obtained by typifying a human's impression with respect to a certain object.

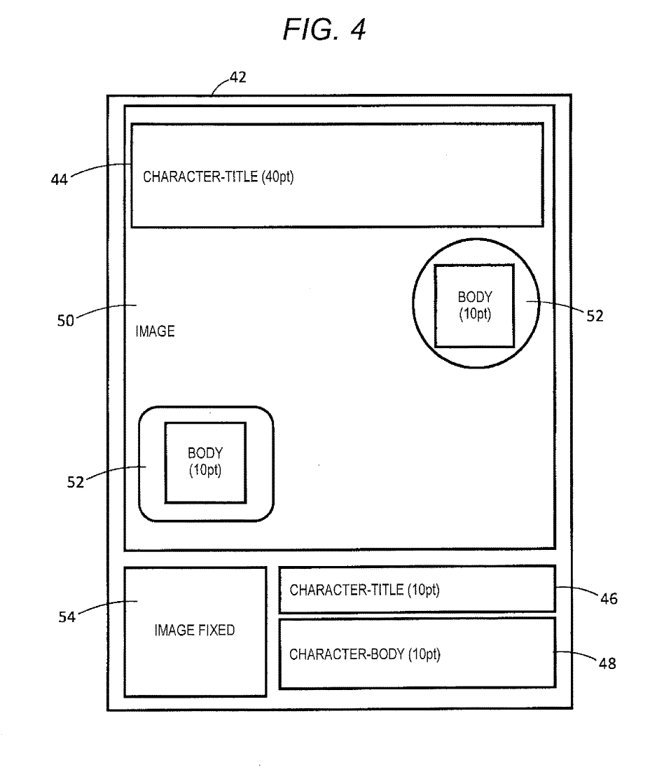

The template is constituted by, for example, one or plural types of objects (design items, design parts). In templates of a flyer and an advertisement, an object is, for example, a title character object, a body character object, an image object, a figure object, or the like. The image object is, for example, image data in a bitmap format. The figure object is, for example, figure data shown in a vector format. Plural different design elements specifying the design of the object belong to each object, and the template is constituted by design elements of the respective objects. The template will be described later in detail with reference to FIG. 4.

The impression map storage unit 20 stores data of a template impression map (template taste map) and data of an object impression map (object taste map). As the object impression maps, impression maps such as a title character impression map, a body character impression map, an image impression map, a figure color impression map, and a figure shadow impression map are stored in the impression map storage unit 20.

The template impression map is a multi-dimensional map in which plural templates (plural templates having different tastes) which evoke different tastes are mapped in accordance with tastes (impressions) evoked by the respective templates. In other words, the template impression map is a map indicating variations in the design of a template. Tastes evoked by the respective templates correspond to coordinates on the template impression map, and the templates are disposed on the template impression map in accordance with the tastes evoked by the respective templates.

The object impression map is a multi-dimensional map in which plural different design elements belonging to an object are mapped in accordance with tastes evoked by the design elements belonging to the object. In other words, the object impression map is a map indicating variations in the design of an object. In the object impression map, the design elements are mapped in accordance with the same conditions as the mapping conditions in the template impression map. Tastes evoked by the respective design elements belonging to the object correspond to coordinates on the object impression map, and the design elements are disposed on the object impression map in accordance with the tastes evoked by the respective design elements. An object impression map is created for each object. For example, a different object impression map is created for each business card or each flyer. The same is true of other objects. Meanwhile, an object impression map which is common to plural objects may be used depending on the type of object.

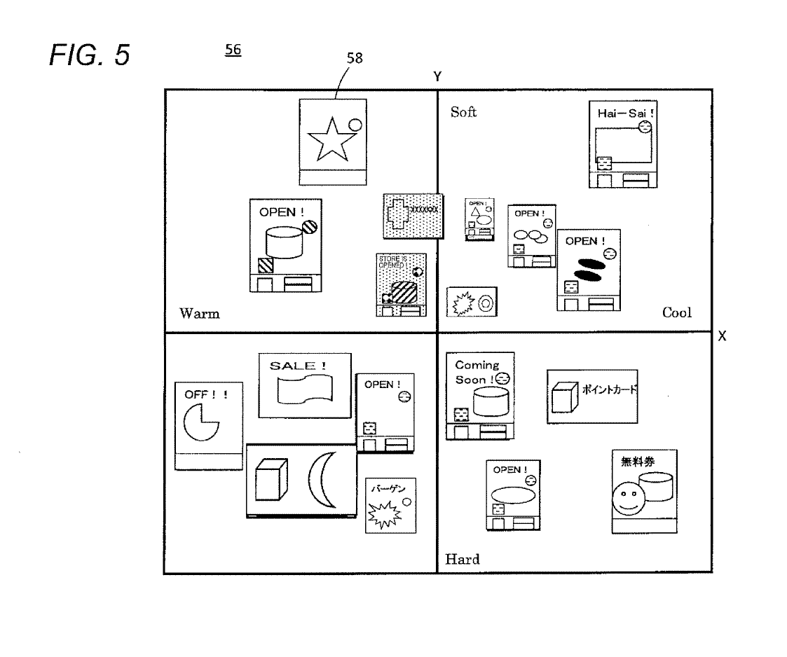

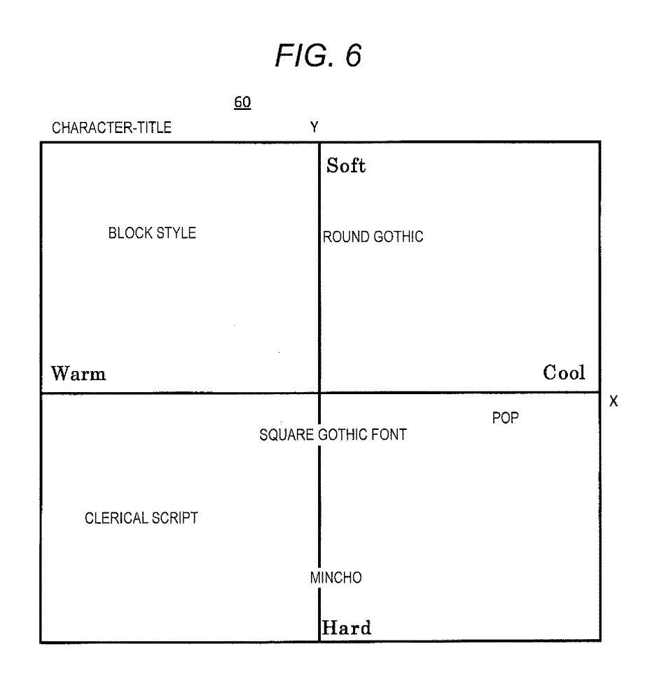

The template impression map and the object impression map are, for example, n-dimensional maps specified by an n-dimensional (n is an integer equal to or greater than 2) axis, and are two-dimensional maps specified by a two-dimensional axis, as an example. The template impression map will be described later in detail with reference to FIG. 5. The object impression map will be described later in detail with reference to FIGS. 6 to 10.

The history information storage unit 22 stores use history information indicating a use history for each template. In the use history information, for example, a template ID of each template and the number of times of use (use frequency) of each template are associated with each other. The number of times of use is, for example, the number of times of copying of a template (the number of times of copying, a copying frequency), the number of times of downloading of a template (the number of times of downloading, a downloading frequency), the number of times of access to a template (the number of times of access, an access frequency), or the like. A use history of a template is managed by the control unit 30. The control unit 30 counts the number of times of use of each template, and updates use history information every time the template is used. For example, in a case where a user downloads a template to edit the template using the terminal apparatus 12, the history of the downloading is stored in the history information storage unit 22 as a use history.

An output creating unit 24 creates an output using a template. The output creating unit 24 edits a specific template designated by a user in accordance with, for example, an instruction for editing which is given by the user. Thereby, an output (image data or the like) of an object is created. For example, in a case where a template of a business card is edited, an output (image data or the like) of the business card is created. The output may be transmitted from the design creating apparatus 10 through the communication channel N to the terminal apparatus 12 or may be printed out.

An impression map creating unit 26 maps plural templates evoking different tastes on a multi-dimensional map in accordance with tastes evoked by the respective templates to thereby create a template impression map. The impression map creating unit 26 creates the template impression map using, for example, an object impression map. A process performed by the impression map creating unit 26 will be described later in detail.

A UT unit 28, which is a user interface, includes a display unit and an operation unit. The display unit is a display device such as a liquid crystal display, and the operation unit is an input device such as a keyboard, a mouse, or a touch panel. Meanwhile, the UI unit 28 may not be provided in the design creating apparatus 10.

The control unit 30 controls the operation of each unit of the design creating apparatus 10. In addition, the control unit 30 includes a display control unit 32. The display control unit 32 displays a map portion within a region to be displayed which is provided on a template impression map, on a display device. For example, the display control unit 32 displays the map portion within the region to be displayed on the terminal apparatus 12 through the communication channel N.

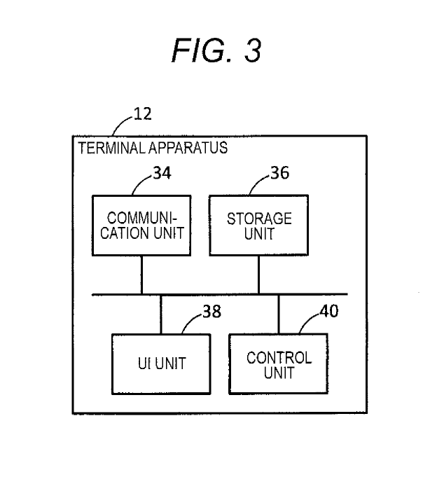

Hereinafter, the terminal apparatus 12 will be described in detail with reference to FIG. 3. FIG. 3 shows a configuration of the terminal apparatus 12. A communication unit 34, which is a communication interface, has a function of transmitting data to another apparatus and a function of receiving data from another apparatus through the communication channel N. For example, information indicating an instruction for editing a template or the like is transmitted to the design creating apparatus 10 by the communication unit 34, and information such as a template impression map or a template which is transmitted from the design creating apparatus 10 may be received by the communication unit. A storage unit 36, which is a storage device such as a hard disk, stores programs, data, and the like. A UI unit 38, which is a user interface, includes a display unit and an operation unit. The operation unit is an input device such as a keyboard, a mouse, or a touch panel. The control unit 40 controls the operation of each unit of the terminal apparatus 12.

Hereinafter, the design creating apparatus 10 will be described by taking a specific example.

First, a template will be described in detail with reference to FIG. 4. FIG. 4 shows an example of a template regarding a flyer or an advertisement. A template 42 is constituted by, for example, title character objects 44 and 46, a body character object 48, an image object 50, a figure object 52, and an image object 54 of which the change is prohibited. The title character objects 44 and 46, the body character object 48, the image object 50, and the figure object 52 are objects of which the designs are permitted to be changed. The image object 54 of which the change is prohibited is an object of which the design is prohibited from being changed. The image object 50 is, for example, an image in a bitmap format, and the figure object 52 is, for example, a figure in a vector format.

Plural templates are created while making design elements belonging to objects different from each other. Thereby, plural templates having different design elements belonging to objects are created. For example, plural templates are created while making design elements (fonts) belonging to the title character objects 44 and 46. Thereby, plural templates having different design elements (fonts) belonging to the title character objects 44 and 46 are created. The same is true of other objects. In addition, plural different templates are created for each object. Each template is created in advance and is stored in the template storage unit 18.

Next, a template impression map will be described in detail with reference to FIG. 5. FIG. 5 shows a template impression map 56.

The template impression map 56 is, for example, a two-dimensional map specified by two axes (X-axis, Y-axis). Affective information indicating a taste is associated in advance with each set of coordinates on the template impression map 56. A taste corresponding to coordinates on the template impression map 56 is specified by designating the coordinates.

In the template impression map 56, the horizontal axis (X-axis) is an index axis that specifies indexes “Warm” and “Cool” of tastes, and the vertical axis (Y-axis) is an index axis that specifies indexes “Hard” and “Soft” of tastes. For example, an impression of “Cool” becomes stronger toward a right region. In other words, tastes having a stronger feeling of “Cool” toward a right region are associated with each other. On the other hand, an impression of “Warm” becomes stronger toward a left region. In other words, tastes having a stronger feeling of “Warm” toward a left region are associated with each other. In addition, an impression of “Soft” becomes stronger toward an upper region. In other words, tastes having a stronger feeling of “Soft” toward an upper region are associated with each other. On the other hand, a “Hard” feeling becomes stronger toward a lower region. In other words, tastes having a stronger feeling of “Hard” toward a lower region are associated with each other.

Plural templates evoking different tastes or thumbnail images (reduced images) of templates are mapped on the template impression map 56 in accordance with tastes evoked by the respective templates. In the example shown in FIG. 5, thumbnail images 58 of respective templates are mapped on the template impression map 56.

As an example, the template impression map 56 is created on the basis of an affective evaluation (the degree of similarity of an impression) which is obtained by digitizing a taste evoked by a template. The affective evaluation is, for example, a value indicating the degree of evoking of a template with respect to a taste, that is, a value indicating the degree of contribution of the template to the evoking of the taste (value indicating the intensity of an impression). The affective evaluation is obtained by, for example, an affective evaluation test according to a typification 1 type. Coordinates on the template impression map are determined on the basis of the affective evaluation, and each template or each thumbnail image is disposed on the template impression map.

Meanwhile, the template impression map may be a map having three or more dimensions, or may be a map in which a two-dimensional map and a one-dimensional slider are combined with each other.

Next, a title character impression map as an object impression map will be described in detail with reference to FIG. 6. FIG. 6 shows a title character impression map 60.

The title character impression map 60 is a two-dimensional map specified by two axes (X-axis, Y-axis), similar to the template impression map 56. Affective information indicating a taste is associated in advance with each set of coordinates on the title character impression map 60. A taste corresponding to coordinates on the title character impression map 60 is specified by designating the coordinates.

In the title character impression map 60, the horizontal axis (X-axis) is an index axis that specifies indexes “Warm” and “Cool” of tastes, and the vertical axis (Y-axis) is an index axis that specifies indexes “Hard” and “Soft” of tastes. These index axes (X-axis, Y-axis) are the same as the index axes (X-axis, Y-axis) in the template impression map 56. Accordingly, in the title character impression map 60, tastes having a stronger feeling of “Cool” toward a right region are associated with each other, and tastes having a stronger feeling of “Warm” toward a left region are associated with each other, similar to the template impression map 56. In addition, tastes having a stronger feeling of “Soft” toward an upper region are associated with each other, and tastes having a stronger feeling of “Hard” toward a lower region are associated with each other.

Plural different design elements belonging to a title character object are mapped on the title character impression map 60 in accordance with tastes evoked by the design elements belonging to the title character object. In other words, the title character impression map 60 is a map indicating variations in the design of the title character object. The design element belonging to the title character object is, for example, a font of a character. Accordingly, the title character impression map 60 is a map indicating variations in the font of the title character object. Plural design elements (fonts) evoking different tastes, that is, plural design elements (fonts) having different tastes belong to the title character object, and plural design elements (fonts) evoking different tastes are mapped to the title character impression map 60. Tastes evoked by the respective design elements (fonts) belonging to the title character object correspond to coordinates on the title character impression map 60, and the design elements (fonts) are disposed on the title character impression map 60 in accordance with the tastes evoked by the respective design elements (fonts).

In the example shown in FIG. 6, pieces of information indicating fonts (Pop, Round Gothic, Square Gothic, Mincho, and the like) as design elements are mapped on the title character impression map 60 in accordance with tastes evoked by the fonts.

As an example, the title character impression map 60 is created on the basis of an affective evaluation obtained by digitizing a taste evoked by a design element. The affective evaluation is, for example, a value indicating the degree of evoking of a design element (font) of a title character object with respect to a taste, that is, a value indicating the degree of contribution of the design element (font) to the evoking of the taste. Coordinates on the title character impression map 60 are determined on the basis of the affective evaluation, and each design element (font) is disposed on the title character impression map 60.

Meanwhile, the title character impression map may be a map having three or more dimensions.

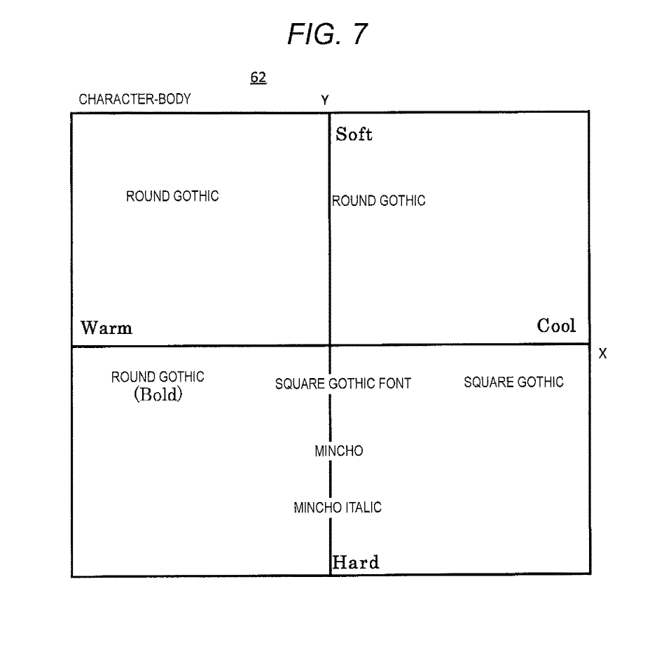

Next, a body character impression map as an object impression map will be described in detail with reference to FIG. 7. FIG. 7 shows a body character impression map 62.

The body character impression map 62 is a two-dimensional map specified by two axes (X-axis, Y-axis), similar to the template impression map 56. Affective information indicating a taste is associated in advance with each set of coordinates on the body character impression map 62. A taste corresponding to coordinates on the body character impression map 62 is specified by designating the coordinates.

In the body character impression map 62, the horizontal axis (X-axis) is an index axis that specifies indexes “Warm” and “Cool” of tastes, and the vertical axis (Y-axis) is an index axis that specifies indexes “Hard” and “Soft” of tastes. These index axes (X-axis, Y-axis) are the same as the index axes (X-axis, Y-axis) in the template impression map 56. Accordingly, in the body character impression map 62, tastes having a stronger feeling of “Cool” toward a right region are associated with each other, and tastes having a stronger feeling of “Warm” toward a left region are associated with each other, similar to the template impression map 56. In addition, tastes having a stronger feeling of “Soft” toward an upper region are associated with each other, and tastes having a stronger feeling of “Hard” toward a lower region are associated with each other.

Plural different design elements belonging to a body character object are mapped on the body character impression map 62 in accordance with tastes evoked by the design elements belonging to the body character object. In other words, the body character impression map 62 is a map indicating variations in the design of the body character object. The design element belonging to the body character object is, for example, a font of a character. Accordingly, the body character impression map 62 is a map indicating variations in the font of the body character object. Plural design elements (fonts) evoking different tastes, that is, plural design elements (fonts) having different tastes belong to the body character object, and plural design elements (fonts) evoking different tastes are mapped to the body character impression map 62. Tastes evoked by the respective design elements (fonts) belonging to the body character object correspond to coordinates on the body character impression map 62, and the design elements (fonts) are disposed on the body character impression map 62 in accordance with the tastes evoked by the respective design elements (fonts).

In the example shown in FIG. 7, pieces of information indicating fonts (Pop, Round Gothic, Square Gothic, Mincho, and the like) as design elements are mapped on the body character impression map 62 in accordance with tastes evoked by the fonts.

As an example, the body character impression map 62 is created on the basis of an affective evaluation obtained by digitizing a taste evoked by a design element. The affective evaluation is, for example, a value indicating the degree of evoking of a design element (font) of a body character object with respect to a taste, that is, a value indicating the degree of contribution of the design element (font) to the evoking of the taste. Coordinates on the body character impression map 62 are determined on the basis of the affective evaluation, and each design element (font) is disposed on the body character impression map 62.

Meanwhile, the body character impression map may be a map having three or more dimensions.

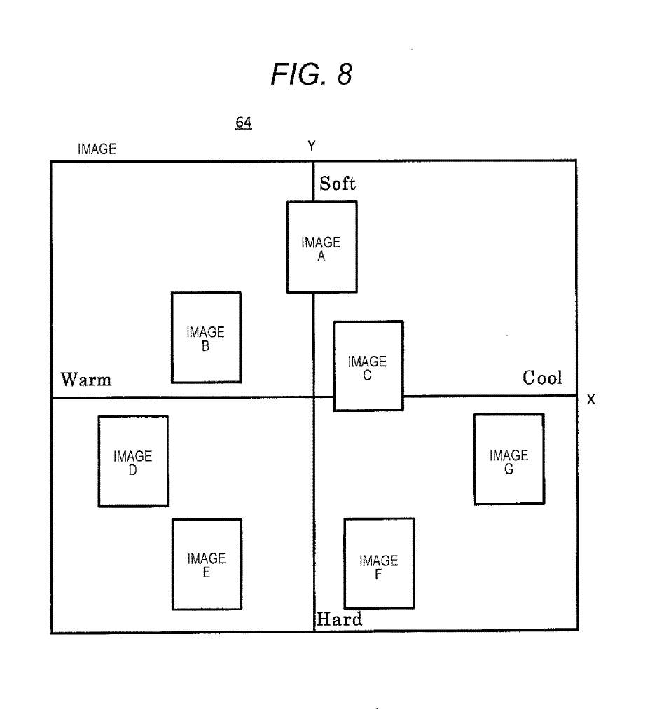

Next, an image impression map as an object impression map will be described in detail with reference to FIG. 8. FIG. 8 shows an image impression map 64 of a flyer or an advertisement.

The image impression map 64 is, for example, a two-dimensional map specified by two axes (X-axis, Y-axis), similar to the template impression map 56. Affective information indicating a taste is associated in advance with each set of coordinates on the image impression map 64. A taste corresponding to coordinates on the image impression map 64 is specified by designating the coordinates.

In the image impression map 64, the horizontal axis (X-axis) is an index axis that specifies indexes “Warm” and “Cool” of tastes, and the vertical axis (Y-axis) is an index axis that specifies indexes “Hard” and “Soft” of tastes. These index axes (X-axis, Y-axis) are the same as the index axes (X-axis, Y-axis) in the template impression map 56. Accordingly, in the image impression map 64, tastes having a stronger feeling of “Cool” toward a right region are associated with each other, and tastes having a stronger feeling of “Warm” toward a left region are associated with each other, similar to the template impression map 56. In addition, tastes having a stronger feeling of “Soft” toward an upper region are associated with each other, and tastes having a stronger feeling of “Hard” toward a lower region are associated with each other.

Plural different design elements belonging to an image object are mapped on the image impression map 64 in accordance with tastes evoked by the design elements belonging to the image object. In other words, the image impression map 64 is a map indicating variations in the design of the image object. The design element belonging to the image object is, for example, image data in a bitmap format. Accordingly, the image impression map 64 is a map indicating variations in an image. Plural design elements (images) evoking different tastes, that is, plural design elements (images) having different tastes belong to the image object, and plural design elements (images) evoking different tastes are mapped to the image impression map 64. Tastes evoked by the respective design elements (images) belonging to the image object correspond to coordinates on the image impression map 64, and the design elements (images) are disposed on the image impression map 64 in accordance with the tastes evoked by the respective design elements (images).

In the example shown in FIG. 8, images A to G as design elements are disposed on the image impression map 64 in accordance with tastes evoked by the images.

As an example, the image impression map 64 is created on the basis of an affective evaluation obtained by digitizing a taste evoked by a design element. The affective evaluation is, for example, a value indicating the degree of evoking of a design element (image) of an image object with respect to a taste, that is, a value indicating the degree of contribution of the design element (image) to the evoking of the taste. Coordinates on the image impression map 64 are determined in accordance with the affective evaluation, and each design element (image) is disposed on the image impression map 64.

Meanwhile, the image impression map may be a map having three or more dimensions.

Next, a figure color impression map and a figure shadow impression map as object impression maps will be described in detail. The figure color impression map and the figure shadow impression map are multi-dimensional maps in which plural different design elements belonging to a figure object are mapped in accordance with tastes evoked by the design elements belonging to the figure object. In other words, the figure color impression map and the figure shadow impression map are maps indicating variations in the design of a figure object. The design elements belonging to the figure object are, for example, the color of a figure (color in which the inside of the figure is painted out) and the shadow of a figure (permeability of the inside of the figure). Accordingly, the figure color impression map is a map indicating variations in the color of a figure, and the figure shadow impression map is a map indicating variations in the shadow of a figure.

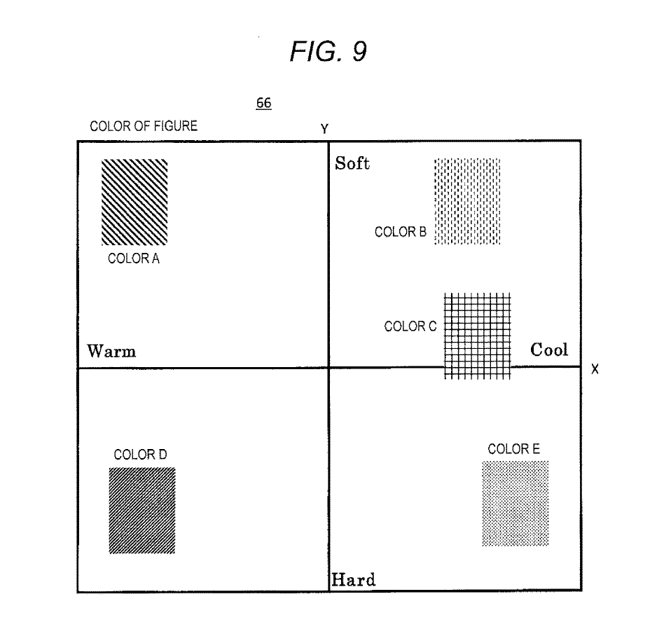

FIG. 9 shows a figure color impression map 66. The figure color impression map 66 is a two-dimensional map specified by two axes (X-axis, Y-axis), similar to the template impression map 56. Affective information indicating a taste is associated in advance with each set of coordinates on the figure color impression map 66. A taste corresponding to coordinates on the figure color impression map 66 is specified by designating the coordinates.

In the figure color impression map 66, the horizontal axis (X-axis) is an index axis that specifies indexes “Warm” and “Cool” of tastes, and the vertical axis (Y-axis) is an index axis that specifies indexes “Hard” and “Soft” of tastes. These index axes (X-axis, Y-axis) are the same as the index axes (X-axis, Y-axis) in the template impression map 56. Accordingly, in the figure color impression map 66, tastes having a stronger feeling of “Cool” toward a right region are associated with each other, and tastes having a stronger feeling of “Warm” toward a left region are associated with each other, similar to the template impression map 56. In addition, tastes having a stronger feeling of “Soft” toward an upper region are associated with each other, and tastes having a stronger feeling of “Hard” toward a lower region are associated with each other.

Plural design elements (colors of figures) evoking different tastes, that is, plural design elements (colors of figures) having different tastes belong to a figure object. Plural design elements (colors of figures) evoking different tastes are mapped to the figure color impression map 66. Tastes evoked by the respective design elements (colors of figures) belonging to the figure object correspond to coordinates on the figure color impression map 66, and the design elements (colors of figures) are disposed on the figure color impression map 66 in accordance with the tastes evoked by the respective design elements (colors of figures).

In the example shown in FIG. 9, colors A to E of figures as design elements are disposed on the figure color impression map 66 in accordance with tastes evoked by the colors.

As an example, the figure color impression map 66 is created on the basis of an affective evaluation obtained by digitizing a taste evoked by a design element. The affective evaluation is, for example, a value indicating the degree of evoking of a design element (color of a figure) of a figure object with respect to a taste, that is, a value indicating the degree of contribution of the design element (color of a figure) to the evoking of the taste. Coordinates on the figure color impression map 66 are determined in accordance with the affective evaluation, and each design element (color of a figure) is disposed on the figure color impression map 66.

Meanwhile, the figure color impression map may be a map having three or more dimensions.

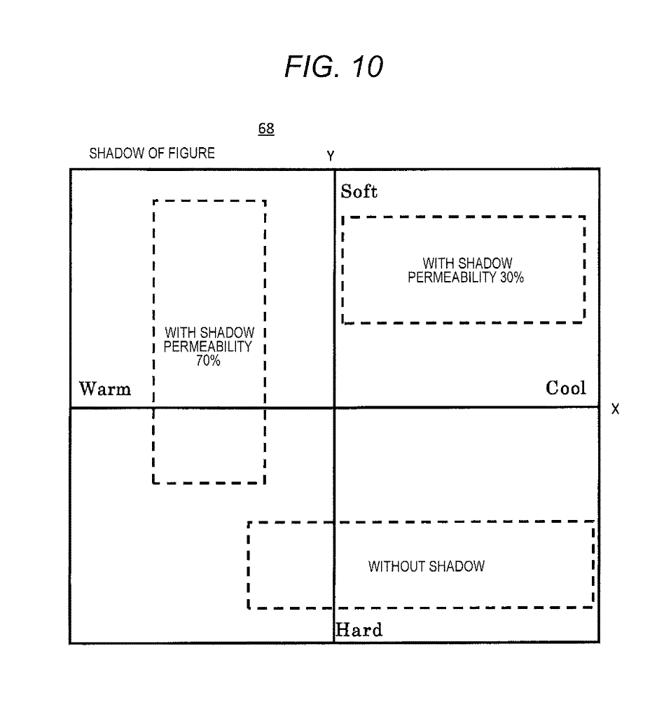

FIG. 10 shows a figure shadow impression map 68. The figure shadow impression map 68 is a two-dimensional map specified by two axes (X-axis, Y-axis), similar to the template impression map 56. Affective information indicating a taste is associated in advance with each set of coordinates on the figure shadow impression map 68. A taste corresponding to coordinates on the figure shadow impression map 68 is specified by designating the coordinates.

In the figure shadow impression map 68, the horizontal axis (X-axis) is an index axis that specifies indexes “Warm” and “Cool” of tastes, and the vertical axis (Y-axis) is an index axis that specifies indexes “Hard” and “Soft” of tastes. These index axes (X-axis, Y-axis) are the same as the index axes (X-axis, Y-axis) in the template impression map 56. Accordingly, in the figure shadow impression map 68, tastes having a stronger feeling of “Cool” toward a right region are associated with each other, and tastes having a stronger feeling of “Warm” toward a left region are associated with each other, similar to the template impression map 56. In addition, tastes having a stronger feeling of “Soft” toward an upper region are associated with each other, and tastes having a stronger feeling of “Hard” toward a lower region are associated with each other.

Plural design elements (shadows of figures) evoking different tastes, that is, plural design elements (shadows of figures) having different tastes belong to a figure object. Plural design elements (shadows of figures) evoking different tastes are mapped to the figure shadow impression map 68. Tastes evoked by the respective design elements (shadows of figures) belonging to the figure object correspond to coordinates on the figure shadow impression map 68, and the design elements (shadows of figures) are disposed on the figure shadow impression map 68 in accordance with the tastes evoked by the respective design elements (shadows of figures).

In the example shown in FIG. 10, a permeability of 70% (with a shadow), a permeability of 30% (with a shadow), and a permeability of 0% (without a shadow) are disposed on the figure shadow impression map 68 in accordance with tastes evoked by figures as design elements.

As an example, the figure shadow impression map 68 is created on the basis of an affective evaluation obtained by digitizing a taste evoked by a design element. The affective evaluation is, for example, a value indicating the degree of evoking of a design element (shadow of a figure) of a figure object with respect to a taste, that is, a value indicating the degree of contribution of the design element (shadow of a figure) to the evoking of the taste. Coordinates on the figure shadow impression map 68 are determined in accordance with the affective evaluation, and each design element (shadow of a figure) is disposed on the figure shadow impression map 68.

Meanwhile, the figure shadow impression map may be a map having three or more dimensions.

The above-mentioned template impression map 56 may be created in advance and may be stored in the impression map storage unit 20, or may be created by the impression map creating unit 26 each time in accordance with an instruction for displaying the template impression map 56. In addition, the object impression maps (the title character impression map 60, the body character impression map 62, the image impression map 64, the figure color impression map 66, and the figure shadow impression map 68) are created in advance and are stored in the impression map storage unit 20.

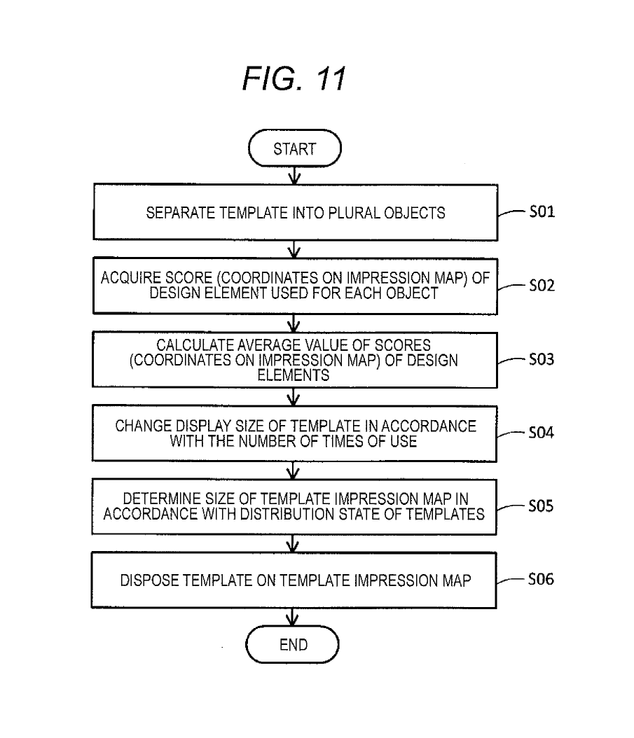

Next, a process of creating a template impression map by the impression map creating unit 26 will be described in detail with reference to FIG. 11. A flow chart showing the process is shown in FIG. 11.

First, a user gives an instruction for displaying a template impression map using the terminal apparatus 12. Information indicating the instruction for display is transmitted from the terminal apparatus 12 through the communication channel N to the design creating apparatus 10. The impression map creating unit 26 creates a template impression map in accordance with the instruction for display. Hereinafter, a process performed by the impression map creating unit 26 will be described.

The impression map creating unit 26 acquires a template to be mapped from the template storage unit 18, and separates the template into plural objects (S01). For example, in the example shown in FIG. 4, the template 42 to be mapped is separated into the title character objects 44 and 46, the body character object 48, the image object 50, and the figure object 52.

Next, the impression map creating unit 26 acquires an affective evaluation (information indicating coordinates on an object impression map) of a design element which is used for each object in a template to be mapped, with reference to each object impression map (S02). Specifically, the impression map creating unit 26 acquires an affective evaluation (information indicating coordinates on the title character impression map 60) of a design element (font) which is used for the title character objects 44 and 46 of the template 42 with reference to the title character impression map 60 shown in FIG. 6. In a case where the design element (font) which is used for the title character objects 44 and 46 is, for example, “Round Gothic”, the impression map creating unit 26 acquires information indicating coordinates of the design element of “Round Gothic” on the title character impression map 60. With respect to other objects, the impression map creating unit 26 also acquires an affective evaluation (information indicating coordinates) of a design element used, from the corresponding object impression map.

Next, the impression map creating unit 26 calculates an average value (average coordinates) of affective evaluations (pieces of information indicating coordinates on respective object impression maps) which are used for respective objects (S03). In the example shown in FIG. 4, an average value (average coordinates) between scores (coordinates) of design elements (fonts) which are used for the title character objects 44 and 46, scores (coordinates) of design elements (fonts) which are used for the body character object 48, scores (coordinates) of design elements (images) which are used for the image object 50, and scores (coordinates) of design elements (colors of figures, shadows) which are used for the figure object 52 is calculated. The average value (average coordinates) of the affective evaluations is equivalent to an affective evaluation (coordinates on a template impression map) of a template to be mapped.

Next, the impression map creating unit 26 acquires use history information of a template to be mapped from the history information storage unit 22, and determines a display size of the template on the template impression map in accordance with the number of times of use indicated by the use history information (S04). For example, the impression map creating unit 26 creates a thumbnail image (reduced image) of the template to be mapped, and determines a display size of the thumbnail image. Specifically, the impression map creating unit 26 increases a display size of a thumbnail image as the number of times of use of a template increases, and reduces a display size of a thumbnail image as the number of times of use of a template decreases. Thereby, as the number of times of use of a template increases, a thumbnail image of the template becomes more conspicuous on the template impression map.

The impression map creating unit 26 applies the above-mentioned processes of steps S01 to S04 to a template group to be mapped. For example, the impression map creating unit 26 applies the above-mentioned processes of steps S01 to S04 to all of the templates stored in the template storage unit 18.

In a case where a template group to be mapped is designated by a user, the impression map creating unit 26 applies the above-mentioned processes of steps S01 to S04 to the template group designated by the user.

For example, in a case where a user designates a specific object (use) using the terminal apparatus 12, information indicating the specific object (use) is transmitted from the terminal apparatus 12 through the communication channel N to the design creating apparatus 10 as a retrieval key. In this case, the impression map creating unit 26 applies the above-mentioned processes of steps S01 to S04 to a template group associated with the information indicating the object (use). A description will be given by taking a specific example. In a case where an object (use) “flyer” is designated by a user, the impression map creating unit 26 applies the above-mentioned processes of steps S01 to S04 to a template group (template group for a flyer) which is associated with information indicating the object “flyer”.

In addition, in a case where a user designates a specific taste using the terminal apparatus 12, information indicating the specific taste is transmitted from the terminal apparatus 12 through the communication channel N to the design creating apparatus 10 as a retrieval key. In this case, the impression map creating unit 26 applies the above-mentioned processes of steps S01 to S04 to a template group associated with the information indicating the taste. A description will be given by taking a specific example. In a case where a taste “dynamic” is designated by a user, the impression map creating unit 26 applies the above-mentioned processes of steps S01 to S04 to a template group associated with information indicating the taste “dynamic”.

Next, the impression map creating unit 26 determines the size of a template impression map on the basis of a distribution state of a template group to be mapped (thumbnail group) on the template impression map and display sizes of respective templates (respective thumbnail images) (S05). For example, the impression map creating unit 26 calculates a distance between the thumbnail images on the template impression map on the basis of affective evaluations (coordinates on the template impression map) of the respective templates, and enlarges or reduces the template impression map in accordance with the distance between the thumbnail images and the display sizes of the respective thumbnail images. For example, the impression map creating unit 26 enlarges or reduces the template impression map so that the thumbnail images do not overlap each other on the template impression map when the thumbnail images are disposed on the template impression map. Specifically, the impression map creating unit 26 reduces the template impression map as the distance between the thumbnail images decreases.

Next, the impression map creating unit 26 disposes a template group to be mapped (thumbnail image group) on the template impression map in accordance with the affective evaluations (coordinates on the template impression map) of the respective templates to be mapped (S06). Thereby, a template impression map having the template group to be mapped (thumbnail image group) mapped thereto is created.

Meanwhile, the processes of steps S01 to S03 may be performed in advance. In this case, each template is associated with its own affective evaluation (information indicating coordinates on the template impression map) in advance, and the impression map creating unit 26 disposes templates (thumbnail images) on the template impression map in accordance with the affective evaluations (coordinates) of the respective templates.

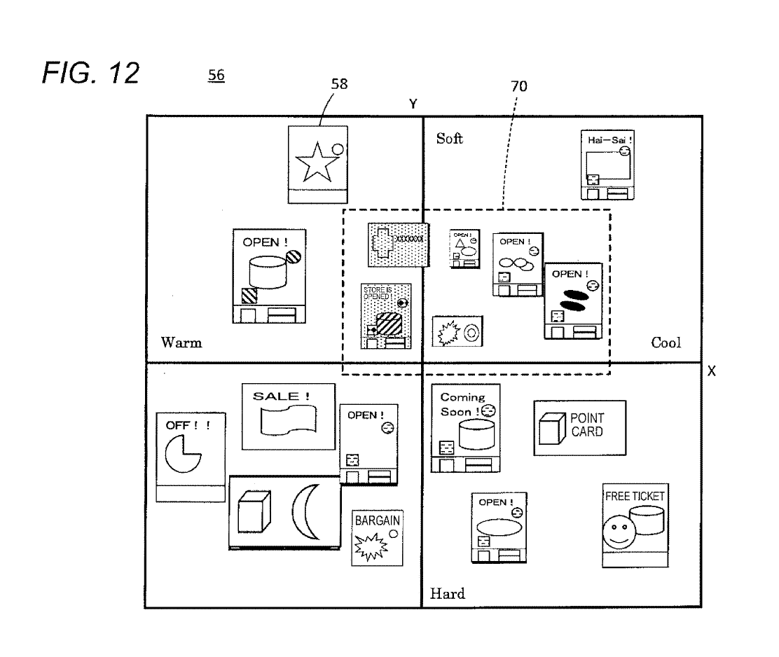

FIG. 12 shows the template impression map 56 which is created in the above-described manner. A region 70 to be displayed is set on the template impression map 56, data in a map portion within the region 70 to be displayed is transmitted from the design creating apparatus 10 through the communication channel N to the terminal apparatus 12, and the map portion is displayed on the UI unit 38 of the terminal apparatus 12. The region 70 to be displayed is a region having a preset shape, and has a rectangular shape in the example shown in FIG. 12. When a user moves the region 70 to be displayed on the template impression map 56 using the UI unit 38 of the terminal apparatus 12, the map portion within the region 70 to be displayed which is a movement destination is displayed on the terminal apparatus 12. In addition, when the user gives an instruction for zooming-in using the UI unit 38 of the terminal apparatus 12, the map portion within the region 70 to be displayed is displayed in an enlarged manner. On the other hand, when the user gives an instruction for zooming-out using the UI unit 38 of the terminal apparatus 12, the map portion within the region 70 to be displayed is displayed in a reduced manner.

When a user selects a specific template is selected among plural templates (thumbnail images) disposed on the template impression map 56 and gives an instruction for editing, the control unit 30 edits the specific template in accordance with the instruction for editing. For example, the type of font in a template, the arrangement, color, and image of a character, and the like are changed by a user. Thereby, an output (for example, image data) based on the template is created. In addition, in a case where a print instruction is executed by a user, a template before editing or an output may be printed out.

As described above, according to this exemplary embodiment, plural templates (thumbnail images) evoking different tastes are disposed on the template impression map 56 in accordance with the tastes evoked by the templates. A user moves the region 70 to be displayed using a taste as a clue, and thus a template (thumbnail image) evoking a taste corresponding to a region which is a movement destination is displayed. Thereby, there is a greater tendency for a template evoking a target taste to be found than in a case where plural templates are displayed so as to be aligned in order of registration or in order of names.

In addition, in the template impression map 56, a thumbnail image of a template is displayed in a more enlarged manner as the number of times of use of the template increases, and a thumbnail image of a template is displayed in a more reduced manner as the number of times of use of the template decreases. Therefore, a user recognizes a use frequency of a template with reference to a display size of a thumbnail image. For example, information for reference in determining popularity or unpopularity of a template is provided to a user as information which is visually easily determined.

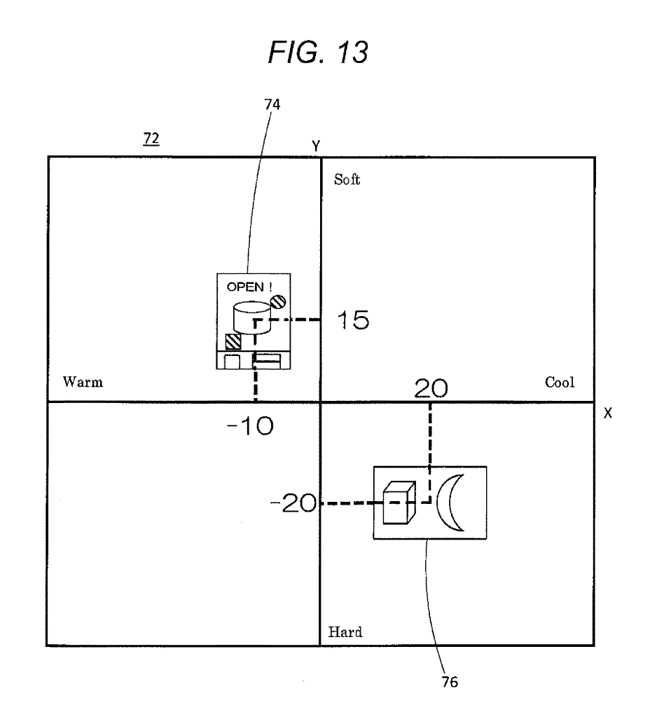

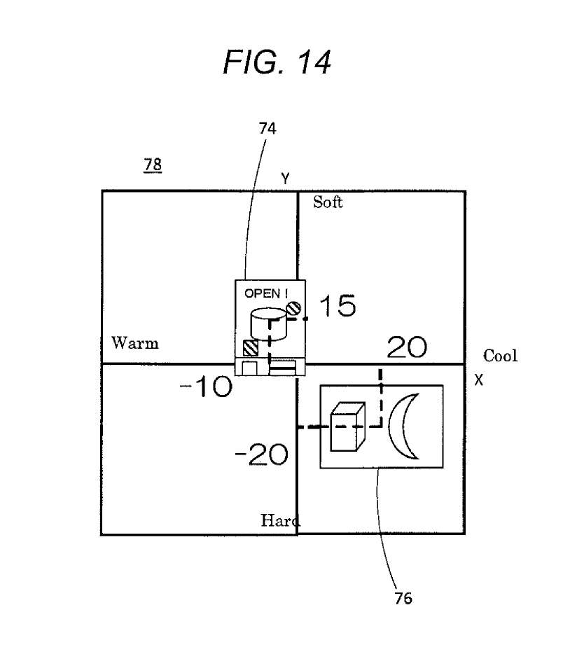

Hereinafter, a case where the size of a template impression map will be described. FIG. 13 shows an unchanged template impression map 72 having a normal size. For ease of description, it is assumed that only thumbnail images 74 and 76 of templates are disposed on the template impression map 72. Coordinates of the thumbnail image 74 are (10, 15), and coordinates of the thumbnail image 76 are (20, −20). A space is formed between the thumbnail images 74 and 76. In this case, the impression map creating unit 26 reduces the template impression map 72 up to a position where the thumbnail images 74 and 76 do not overlap each other, without changing sizes and coordinates of the thumbnail images 74 and 76. Thereby, the scale of the template impression map is reduced. FIG. 14 shows a reduced template impression map 78. In the template impression map 78, the sizes and coordinates of the thumbnail images 74 and 76 are maintained, and only the scale of the map is reduced.

As described above, since a reduction in the template impression map 78 makes a moving distance of a region to be displayed shorter than in a case where the size of the template impression map is fixed at all times, the amount of user's operation is reduced, and there is a greater tendency for a template evoking a target taste to be found. For example, it is assumed that a user designates a specific object (use) or a specific taste as a retrieval key and instructs the retrieval of a template after a template impression map is created using all templates as targets. In this case, since a template corresponding to the retrieval key is used as a template to be mapped, the number of templates to be mapped, that is, the number of templates disposed on the template impression map becomes smaller than a total number of templates. In this case, the impression map creating unit 26 reduces the template impression map in accordance with a distance between the templates (between thumbnail images).

In addition, when the template impression map is created, the size of the template impression map is determined so that templates (thumbnail images) do not overlap each other, and thus there is a greater tendency for the templates (thumbnail images) to be viewed than in a case where the templates overlap each other.

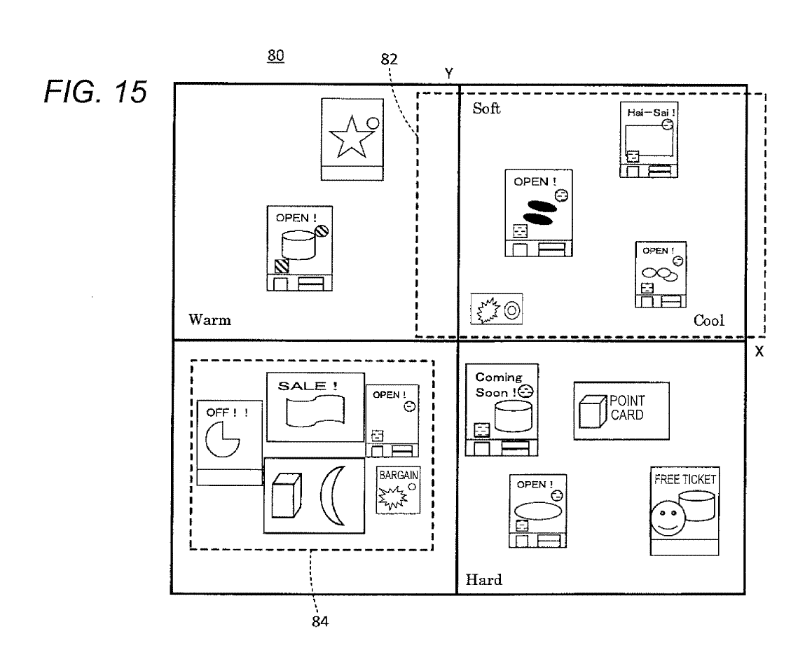

In this exemplary embodiment, the display control unit 32 may change the size of a region to be displayed in accordance with the distribution density of templates (thumbnail images) on the template impression map. This process will be described with reference to FIGS. 15 to 17. FIG. 15 shows a template impression map 80. The display control unit 32 enlarges the size of a region to be displayed as the distribution density of templates (thumbnail images) on the template impression map 80 becomes lower, and reduces the size of a region to be displayed as the distribution density of templates (thumbnail images) becomes higher. In other words, zooming-out is performed as distribution density becomes lower, and zooming-in is performed as distribution density becomes higher. In FIG. 15, a region 82 to be displayed is a region to be displayed in a zooming-out state, and a region 84 to be displayed is a region to be displayed in a zooming-in state.

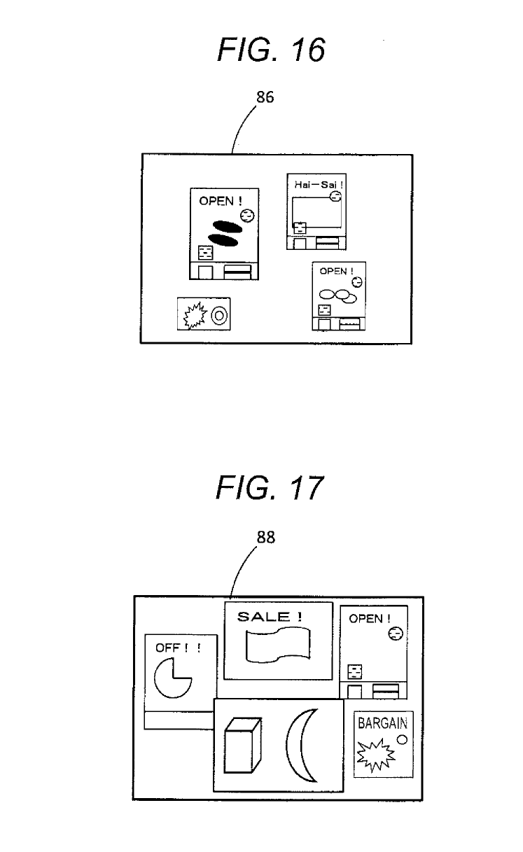

Even when the size of a region to be displayed is changed, the size of a display window (window on which a map portion within a region to be displayed is displayed) which is displayed on the UI unit 38 of the terminal apparatus 12 does not change. In FIGS. 16 and 17, display windows 86 and 88 displayed on the UI unit 38 of the terminal apparatus 12 are shown. A map portion within the region 82 to be displayed is displayed on the display window 86, and a map portion within the region 84 to be displayed is displayed on the display window 88. Sizes of the display windows 86 and 88 are the same as each other. The map portion within the region 82 to be displayed is displayed on the display window 86 in a state where sizes of templates (thumbnail images) within the region 82 to be displayed are maintained and the scale of the map portion within the region 84 to be displayed is reduced.

As described above, the size of a region to be displayed is changed in accordance with the distribution density of templates (thumbnail images) on a template impression map, and thus the visibility of the template impression map is improved as compared to a case where the size of the region to be displayed is fixed at all times, thereby making it easier for a template evoking a target taste to be found.

Specifically, the size of a region to be displayed is enlarged (zooming-out is performed) as the distribution density of templates (thumbnail images) on a template impression map becomes lower, and thus a moving distance of the region to be displayed becomes shorter than in a case where a region to be displayed which has a smaller size is used, thereby reducing the amount of user's operation. In addition, the size of a region to be displayed is reduced (zooming-in is performed) as the distribution density of templates (thumbnail images) on a template impression map becomes higher, and thus the templates are displayed in a more enlarged manner than in a case where a region to be displayed which has a larger size is used, thereby improving visibility.

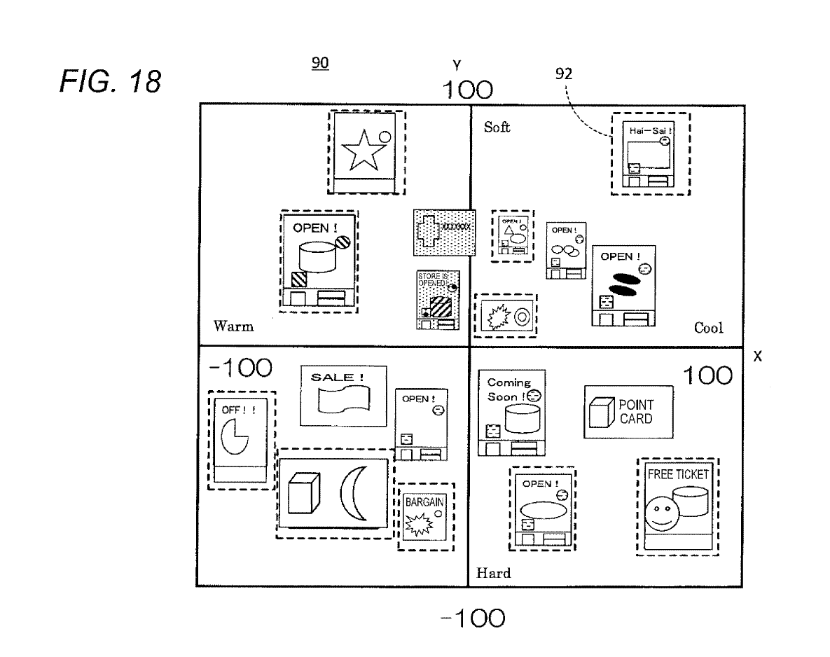

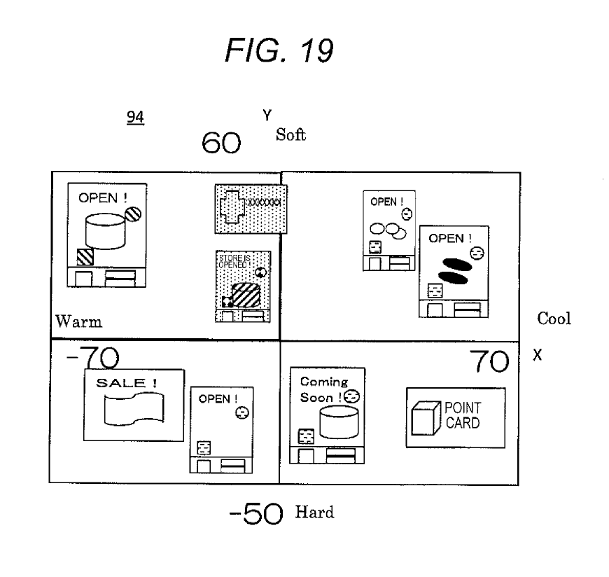

In addition, in this exemplary embodiment, the impression map creating unit 26 may change the maximum value and the minimum value of the scale of a template impression map in accordance with a distribution state of templates (thumbnail images). For example, the impression map creating unit 26 determines the maximum value and the minimum value of the scale so that a template group to be mapped is disposed on a template impression map and a region having no template disposed therein becomes smaller. Hereinafter, this process will be described with reference to FIGS. 18 and 19.

FIG. 18 shows an unchanged template impression map 90 having a normal size. In the template impression map 90, the maximum value of coordinates of the X and Y axes is 100, and the minimum value of coordinates of the X and Y axes is −100. For example, it is assumed that the template impression map 90 is a map which is created with all templates as targets. In the example shown in FIG. 18, templates (thumbnail images) are disposed throughout substantially the entire region on the template impression map 90.

It is assumed that a user designates a specific object (use) or a specific taste as a retrieval key and instructs the retrieval of a template after the template impression map 90 is created. In this case, since a template corresponding to the retrieval key is used as a template to be mapped, the number of templates to be mapped, that is, the number of templates disposed on the template impression map becomes smaller than a total number of templates. In this case, the impression map creating unit 26 changes the maximum value and the minimum value of the scale of the template impression map in accordance with a distribution state of unchanged templates (thumbnail images). For example, it is assumed that a template surrounded by a dashed line region 92 is not selected as a template to be mapped and the other templates are selected as templates to be mapped. In this case, the impression map creating unit 26 reduces the maximum value of the scale of a template impression map and increases the minimum value thereof so that a template to be mapped is included in the template impression map and a region having a template, which is surrounded by the dashed line region 92 and is not a target for mapping, disposed therein is not included in the template impression map.

FIG. 19 shows a template impression map 94 of which the scale is changed. A template which is surrounded by the dashed line region 92 and is not a target for mapping is not disposed in the template impression map 94. The maximum value and the minimum value of the scale of the template impression map 94 are determined so that a template to be mapped is included and a region having a template, which is not a target for mapping, disposed therein is not included. In the example shown in FIG. 19, the maximum value of the X-axis is changed from “100” to “70”, the minimum value of the X-axis is changed from “−100” to “−70”, the maximum value of the Y-axis is changed from “100” to “60”, and the minimum value of the Y-axis is changed from “−100” to “−50”.

As described above, the maximum value and the minimum value of the scale of a template impression map is changed in accordance with a distribution state of templates (thumbnail images) on the template impression map, and thus a region having no template (thumbnail image) disposed therein on the template impression map becomes smaller than in a case where the maximum value and the minimum value of the scale of the template impression map is fixed at all times. Thereby, a region which is a target for the retrieval of a template on the template impression map becomes smaller than in a case where the maximum value and the minimum value of scale are fixed at all times, and thus there is a greater tendency for a template evoking a target taste to be found. For example, the amount of movement of a region to be displayed only has to be small as compared to a case where the maximum value and the minimum value of scale are fixed at all times, and thus the amount of user's operation is reduced.

The above-mentioned design creating apparatus 10 is realized by cooperation of a hardware resource and software, as an example. Specifically, the design creating apparatus 10 includes a processor such as a CPU which is not shown in the drawing. The processor reads out and executes a program stored in a storage device not shown in the drawing, thereby realizing functions of respective units of the design creating apparatus 10. The above-mentioned program is stored in the storage device through a recording medium such as a CD or a DVD or through a communication channel such as a network. Alternatively, the units of the design creating apparatus 10 may be realized by, for example, a hardware resource such as a processor or an electronic circuit. A device such as a memory may be used for the realization. As another example, the units of the design creating apparatus 10 may be realized by a digital signal processor (DSP), a field programmable gate array (FPGA), or the like.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a display control unit that displays a region to be displayed, which is disposed on a multi-dimensional template impression map, on a display unit, the multi-dimensional template impression map being configured such that a plurality of templates related to creation of designs and evoking different impressions are mapped in accordance with impressions evoked by the templates; and
an output creating unit that creates an output using a template selected among the plurality of templates mapped on the template impression map.

2. The information processing apparatus according to claim 1, further comprising:
a map control unit that changes a size of the template impression map in accordance with a distribution state of the plurality of templates on the template impression map.

3. The information processing apparatus according to claim 2,
wherein the map control unit changes a size of the template impression map in accordance with a distance between the templates on the template impression map.

4. The information processing apparatus according to claim 3,
wherein the map control unit reduces a size of the template impression map as the distance between the templates on the template impression map becomes shorter.

5. The information processing apparatus according to claim 2,
wherein the map control unit changes display sizes of the templates on the template impression map for each of the templates in accordance with a use history of the template.

6. The information processing apparatus according to claim 1,
wherein the display control unit causes the display unit to display a map portion within the region to be displayed in a reduced or enlarged manner in accordance with a distribution density of the templates on the template impression map.

7. The information processing apparatus according to claim 1,
wherein each of the templates includes a plurality of objects, and
wherein the information processing apparatus further comprises a creating unit that determines an impression evoked by each of the templates on the basis of impressions evoked by the respective objects in the each of the templates and creates the template impression map.

8. The information processing apparatus according to claim 7,
wherein each of the objects includes a plurality of design elements specifying a design of the each of the objects,
wherein the information processing apparatus further comprises a storage unit, storing an object impression map for each of the objects, which stores a multi-dimensional object impression map in which the plurality of design elements are mapped in accordance with an impression evoked by each of the design elements, and
wherein the creating unit acquires information indicating a position of the each of the design element on the object impression map, which is used for the each of the template, from the object impression map for each of the objects, and determines a position of the template on the template impression map on the basis of the position of the design element for each of the objects, so as to create the template impression map.

9. An information processing method comprising:
displaying a region to be displayed, which is disposed on a multi-dimensional template impression map, on a display unit, the multi-dimensional template impression map being configured such that a plurality of templates related to creation of designs and evoking different impressions are mapped in accordance with impressions evoked by the templates; and
creating an output using a template selected among the plurality of templates mapped on the template impression map.

10. A non-transitory computer readable medium storing a program causing a computer to execute an information processing, the process comprising:
displaying a region to be displayed, which is disposed on a multi-dimensional template impression map, on a display unit, the multi-dimensional template impression map being configured such that a plurality of templates related to creation of designs and evoking different impressions are mapped in accordance with impressions evoked by the templates; and
creating an output using a template selected among the plurality of templates mapped on the template impression map.
